(19) United States
(12) Patent Application Publication
(10) Pub. No.: US 2013/0075542 A1
(43) Pub. Date: Mar. 28, 2013

(54) KEYBOARD STAND

(71) Applicant: Ya-Hsiu Hsu, Taichung City (TW)

(72) Inventor: Ya-Hsiu Hsu, Taichung City (TW)

(21) Appl. No.: 13/239,414

(22) Filed: Sep. 22, 2011

(51) Int. Cl. F16M 11/04; F16M 11/22

(52) U.S. Cl. 248/121; 248/440.1

(57) ABSTRACT

A keyboard stand includes a body having a peripheral wall on the top periphery thereof and a space on the body is defined by the peripheral wall. Two legs respectively extend from two ends of the body. A distance between the two legs is longer than a length of a keyboard and a height of the two legs is higher than a depth of the keyboard.

### BACKGROUND OF THE INVENTION

1. Field of the Invention

The present invention relates to a stand, and more particularly to a keyboard stand.

2. Description of Related Art

Computers are used in almost every type of works including office work. The user usually puts the mouse, the monitor and the keyboard on a desk during the office work.

However, the keyboard or the mouse occupies a lot of space on the desk and make the office work inconvenient for the user. Thus, how to find a sufficient space for the keyboard or the mouse is an important issue.

The present invention has arisen to mitigate and/or obviate the disadvantages of the conventional way of allocation of keyboard so that the desk top has more and sufficient space to be used.

### SUMMARY OF THE INVENTION

The main objective of the present invention is to provide an improved stand.

To achieve the objective, a keyboard stand comprises a body having a peripheral wall formed on the top periphery thereof and the peripheral wall defining a space on the top of the body, two legs respectively extending from two ends of the body and a distance between the two legs being longer than a length of a keyboard, the body standing via the legs, a height of the two legs being higher than a depth of the keyboard. Wherein two rails are respectively mounted to two insides of the two legs; a support is connected between the two rails; an accommodating area is defined on a top of the support and the keyboard is accommodated on the accommodating area.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a keyboard stand of the present invention;

FIG. 2 shows the keyboard stand of the present invention, while a keyboard is in use;

FIG. 3 shows the keyboard stand of the present invention, while the keyboard is not in use;

FIG. 4 shows another embodiment of the keyboard stand of the present invention; and

FIG. 5 shows the keyboard stand of the present invention while the keyboard is on the desk.

### DETAILED DESCRIPTION OF THE INVENTION

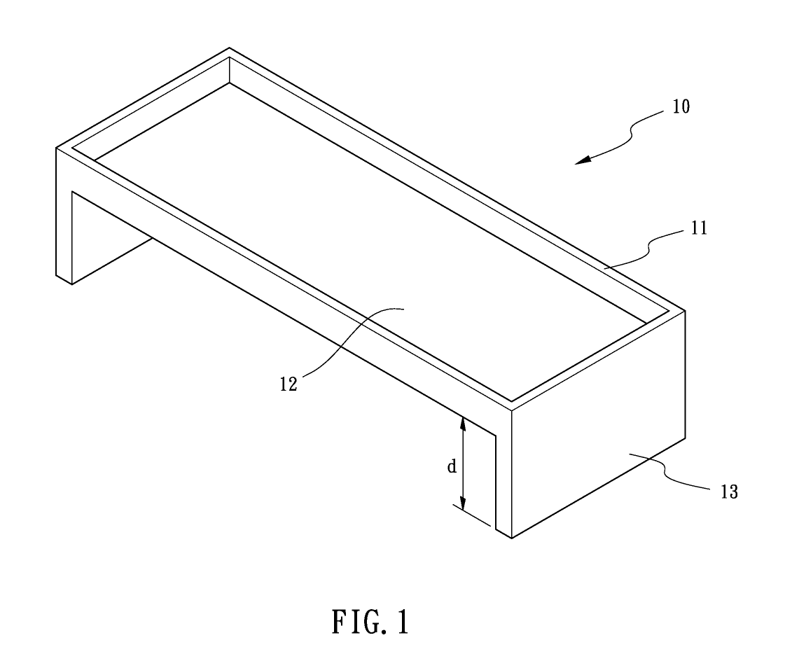

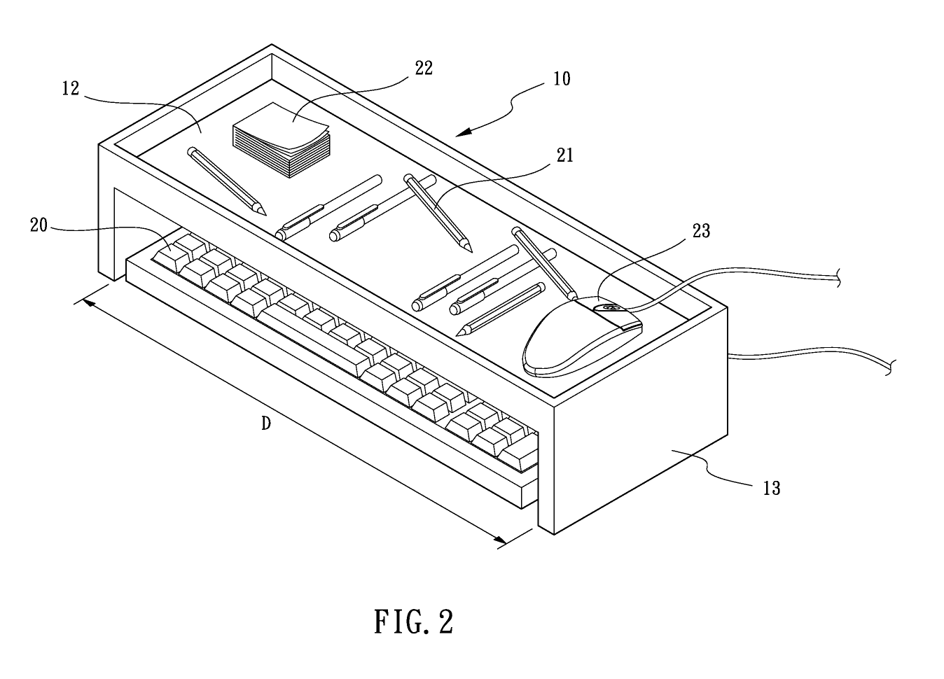

Referring to FIGS. 1, 2, a keyboard stand in accordance with the present invention comprises a body 10 having a peripheral wall 11 formed on the top periphery thereof and the peripheral wall 11 defines a space 12 on the top of the body 10. Two legs 13 extend from two ends of the body 10 respectively and the distance between the two legs 13 is longer than the length “D” of a keyboard 20 so that the body 10 stands via the legs 13. The height “d” of the two legs 13 is higher than the depth of the keyboard 20.

When the keyboard stand is in use, the body 10 is put close to the monitor of the computer. The distance between the two legs 13 of the body 10 is longer than the length “D” of the keyboard 20 so that when the user does not use the keyboard 20, the keyboard 20 is received beneath the body 10 and the space 12 is used to accommodating pens 21, notes 22 or a mouse 23.

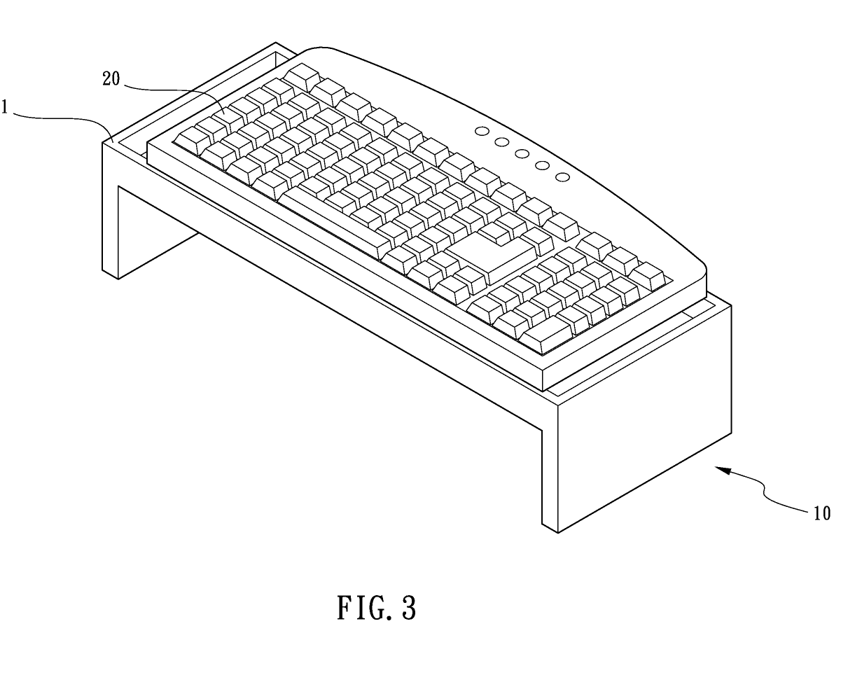

When the user wants to use the keyboard 20, the keyboard 20 is pulled out from the body 10. After use, the keyboard 20 can be pushed back into the board 10 or put on the peripheral wall 11 of the body 10. Under this arrangement, the space beneath the body 10 can be used in other way as shown in FIG. 3.

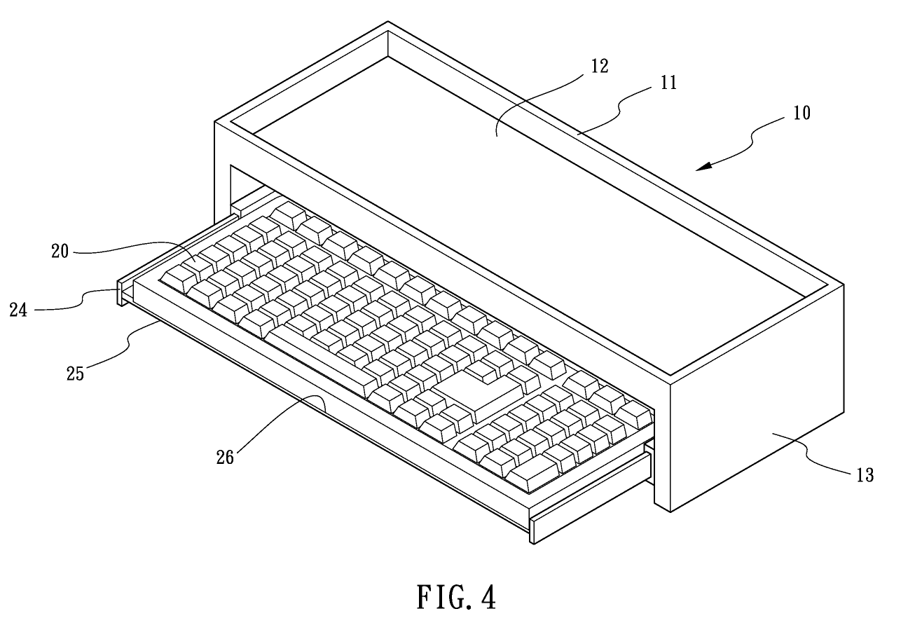

Referring to FIG. 4, in order to position the keyboard 20, two rails 24 are respectively mounted to two insides of the two legs 13 of the body 10. A support 25 is connected between the two rails 24 and an accommodating area 26 is defined on the top of the support 25. The accommodating area 26 is sized to be larger than the size of the keyboard 20 so that the keyboard 20 is accommodated in the accommodating area 26.

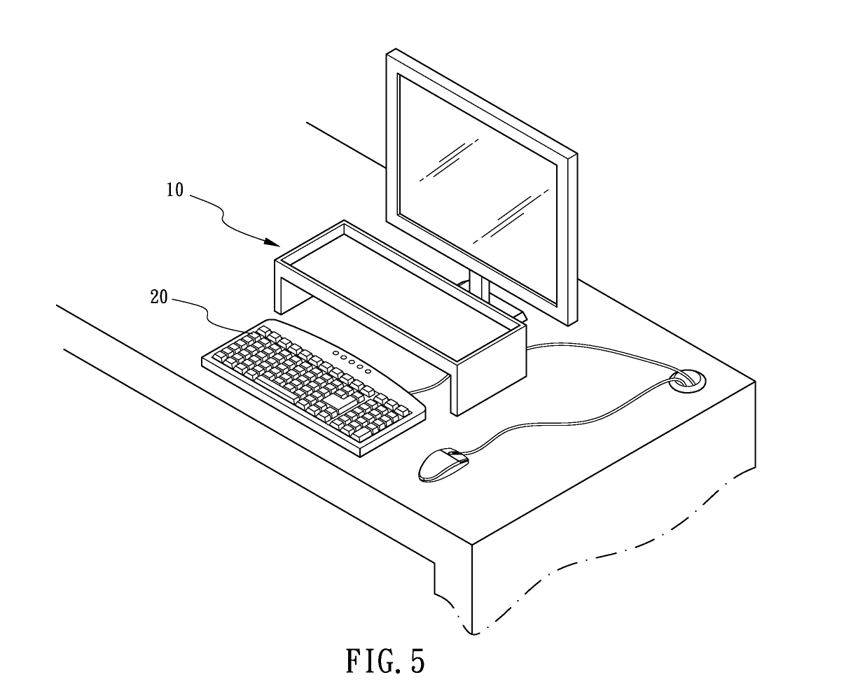

By using the keyboard stand, the desk top is organized as shown in FIG. 5.

Although the invention has been explained in relation to its preferred embodiment, it is to be understood that many other possible modifications and variations can be made without departing from the spirit and scope of the invention as hereinafter claimed.

What is claimed is:

1. A keyboard stand comprising:
a body having a peripheral wall formed on the top periphery thereof and the peripheral wall defining a space on the top of the body;
two legs respectively extending from two ends of the body and a distance between the two legs being longer than a length of a keyboard, the body standing via the legs; and
a height of the two legs being higher than a depth of the keyboard.

2. The keyboard stand as claimed in claim 1, wherein two rails are respectively mounted to two insides of the two legs; a support is connected between the two rails; an accommodating area is defined on a top of the support and the keyboard is accommodated on the accommodating area.
